(19) United States
(12) Patent Application Publication
(10) Pub. No.: US 2003/0217357 A1
(43) Pub. Date: Nov. 20, 2003

(54) Monitoring firmware

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/144,925

(22) Filed: May 14, 2002

(51) Int. Cl. G06F 9/44; G06F 9/00; G06F 9/54; G06F 15/163

(52) U.S. Cl. 717/168; 709/310

(57) ABSTRACT

A system and method for managing firmware on network devices wherein a computer program operates a plurality of executables for determining firmware versions, obtaining firmware updates from remote locations over an Internet connection, and updating or installing new firmware on network devices monitored by the computer program.

### FIELD OF THE INVENTION

The present invention relates to monitoring firmware for computing devices. More particularly, the present invention relates to monitoring firmware installed on printing devices and document management devices across a network computer system.

### BACKGROUND OF THE INVENTION

The use and management of printing devices in enterprise environments is well known. As fast as new printing devices are becoming available, so to are new methods and systems for managing the printing devices added to network computing systems. However, with new features and capabilities being added to printing devices on a daily basis, new management methods and tools are needed to keep pace with the rapidly changing technologies.

One well-known printer management system is the Web JetAdmin program offered by Hewlett-Packard®. Web JetAdmin provides a platform for a network administrator to manage network components from a central location or through a single computer capable of communicating with the network being controlled. Once installed on a network computer system, Web JetAdmin may be accessed from anywhere in the world through a web-browser having communication capabilities with the network computer system upon which Web JetAdmin is installed. The Web JetAdmin program therefore allows a network administrator to control and configure the printing devices of a network computer system from any location.

The Web JetAdmin program offers many features that may be used to set-up printing devices or monitor the status of printing devices connected to a network computer system. New printers may be installed on a network computer system and configured with the desired user settings using the Web JetAdmin program. The Web JetAdmin program also serves as a monitor for active printing devices and is capable of warning a network administrator of problems associated with the network printing devices. For instance, error messages associated with one or more printers in a network system may be broadcast to a network administrator through the Web JetAdmin program or interface. Common error messages include messages that may also be broadcast on a printing device, such as low-toner messages, empty paper tray messages, or paper jam messages. Web JetAdmin may also be used to search and organize the printing devices on a network into groups based upon criteria set by the network administrator. This provides the capability to monitor various printing devices according to usage variables, or configure user preferences according to printing device location or size.

The use of device management programs such as Web JetAdmin provide efficient solutions for monitoring and operating multiple devices in enterprise environments. Furthermore, device management programs allow for the optimization of services across a network computer system because the operations of all of the network devices may be monitored and altered in real-time, by one individual, from a central location.

Besides the standard user configurations and options associated with network devices that may be monitored and altered by device management programs, many network devices also include integrated programming that defines or controls the available functions and options of a network device. For instance, many network printing devices include firmware programmed into a read-only memory (ROM) of the printing device. Firmware is essentially a computer program in a printing device memory that provides functionality to the printing device. Various functions may be programmed into the firmware of a printing device to provide additional options, tools and functionality to the printing device. Although many network devices in use today use on variation or another of firmware, device management programs do not provide methods for updating such firmware. Rather, individual programs specific to the firmware for individual network devices must be used to update firmware.

Typically, firmware versions are periodically updated for various printing devices. When the manufacturer updates firmware, new versions of the firmware are provided to users for installation on any devices using the old firmware. To install the firmware on a printing device, a user generally uses a special user interface or program to install the firmware in the ROM of the printing device. Alternatively, firmware may be updated by flashing the new version of the firmware into a flashable memory chip associated with a printing device. Installation of the new firmware version effectively replaces the old firmware, providing the device with the new features associated with the updated firmware. Methods for updating firmware are known and are frequently used to update network devices.

With the advent of the Internet and proliferation of Internet usage more companies are beginning to post firmware updates on Internet web sites so that updated versions of firmware may be downloaded by users for installation on various devices. The Internet provides an efficient and cost effective method for distributing firmware updates.

Although firmware updates may be posted over the Internet it is time consuming for a network administrator to check individual web sites for firmware updates on a regular basis. Additionally, it may be cumbersome to install firmware updates on multiple devices in an enterprise environment where the firmware updates must be done on individual devices one at a time. Thus, automatically checking the Internet for the availability of firmware updates for multiple devices on a network computer system may be desirable. Additionally, it is desirable to update the firmware of multiple network devices at one time, from a central location.

### SUMMARY OF THE INVENTION

In one embodiment of the present invention a computer program, or diagnostic tool, is executed on a computer in communication with a network system for monitoring and updating firmware of network devices. The diagnostic tool may be used to identify and monitor those devices on a network system that use, or are controlled in some manner, by firmware. The diagnostic tool may create a database of information about each individual network device and the version of firmware operating on the respective devices. In addition, the diagnostic tool may automatically scour the Internet for updated versions of firmware that may be installed on the network devices monitored by the diagnostic tool. Typically, the network devices may include an embedded Internet address for obtaining firmware updates that may be retrieved and used by the diagnostic tool. In this manner, the diagnostic tool may focus on those Internet locations that may have a firmware upgrade available.

Using the information stored in the databases available to the diagnostic tool, the diagnostic tool may periodically automatically check for firmware updates for certain network devices. If a firmware update is available, the diagnostic tool may automatically update the firmware on a particular device. Alternatively, the diagnostic tool may inform a network administrator of the update through an e-mail or other message, thereby allowing the network administrator to manually update the firmware if an update is desired. Once informed of the possibility of an update, the network administrator may also instruct the diagnostic tool to execute an update, thereby freeing the administrator for other tasks.

In another embodiment of the present invention, the functionality of the diagnostic tool may be incorporated with a network management program such as Web JetAdmin by Hewlett-Packard®. When incorporated with a network management program, the present invention adds additional functionality to the network management program—namely the ability of the network management program to monitor the firmware status of network devices associated with a network being monitored. In addition, the various embodiments of the present invention allow a network management program to access the Internet to automatically search for firmware upgrades. If found, upgrades may be downloaded to the network or automatically installed on the appropriate network devices.

In another embodiment of the present invention, the diagnostic tool, or executables associated therewith, may be used to monitor programs stored in a flash memory of a network device. The flash memory may also be altered or updated with new versions of the programs which may be obtained over the Internet or through other sources.

### DESCRIPTION OF THE DRAWINGS

While the specification concludes with claims particularly pointing out and distinctly claiming that which is regarded as the present invention, the present invention can be more readily ascertained from the following description of embodiments of the invention when read in conjunction with the accompanying drawings in which:

FIG. 1 illustrates a diagram of a network computer system that may be used to carry out the various embodiments of the present invention; and

FIG. 2 illustrates a block diagram of various components that may be used for monitoring and updating firmware according to embodiments of the present invention.

### DETAILED DESCRIPTION OF THE INVENTION

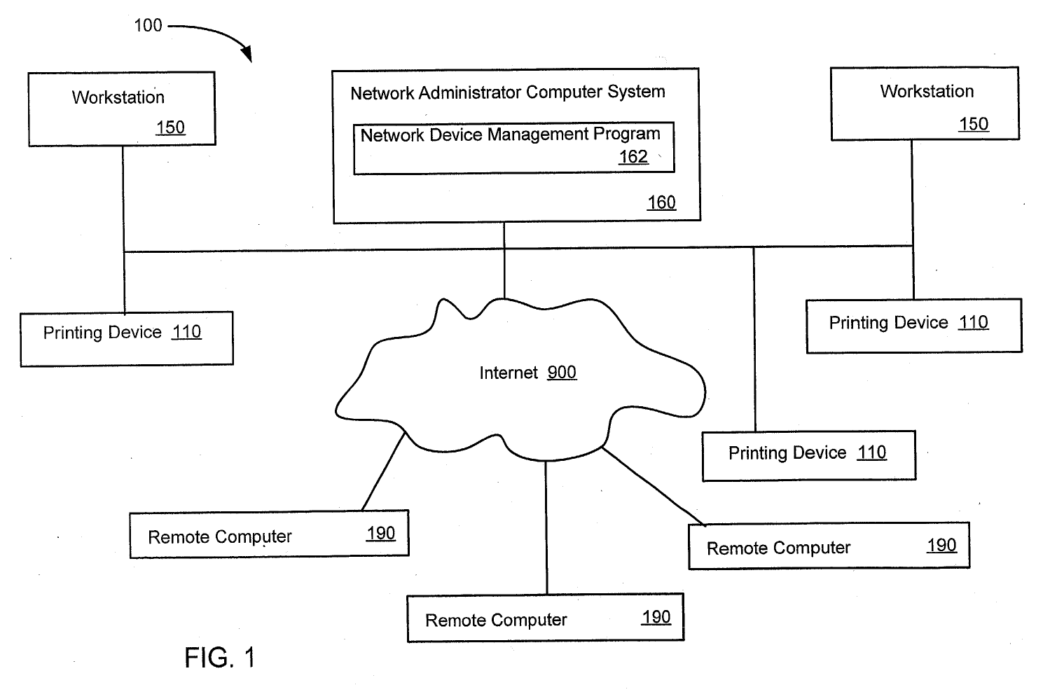

A network computer system 100 that may be used to carry out the various embodiments of the present invention is illustrated in FIG. 1. Multiple network devices, including printing devices 110, workstations 150 and a network administrator computer system 160, may communicate over an intranet or network. The intranet, and hence the network devices, may also be capable of communicating with remote devices through an Internet 900 communication link. Remote computers 190 may also be capable of communicating through the Internet 900.

Printing devices 110 may include devices such as printers, copiers, multifunction printing devices, and the like. Typically, printing devices 110 include one or memories (not shown) for storing information. Most printing devices 110 may also include programmable read-only memory (ROM) for storing firmware. Firmware programmed into the programmable ROM may be used by the printing device 110 to perform various tasks or functions and facilitate the operations of the printing device 110.

Workstations 150 may include computers or other computing devices used by individuals across the network. Typically, a workstation 150 may include a computer system including one or more central processing units, memories, input devices, output devices, and storage devices, as known.

The network administrator computer system 160 may also include a computer system including one or more central processing units, memories, input devices, output devices, and storage devices. In most instances, the network administrator computer system 160 also includes one or more network device management programs 162 operating on the network administrator computer system 160. The network device management program 162 may be used to monitor, control, and analyze the various network devices and components that make up the network system 100. For instance, Hewlett-Packard's® Web JetAdmin program may operate on the network administrator computer system 160 for monitoring and controlling the printing devices 110 associated with the network system 100.

Remote computers 190 may be any type of computer, computing device, or network computing system. Remote computers 190 may host firmware updates in a memory for printing devices 110. Copies of the firmware updates may be downloaded over the Internet 900 from the remote computers 190 to the network administrator computer system 160 or other workstation 150 associated with the network system 100.

In one embodiment of the present invention a diagnostic tool for managing the firmware resident on printing devices 110 is provided. The diagnostic tool may comprise a stand-alone computer program or a plug-in or other extendable program that may be incorporated or associated with a network device management program 162. The diagnostic tool of the present invention allows a network administrator to monitor and update firmware versions on printing devices 110. In addition, the diagnostic tool may provide the capability to monitor the Internet 900 for firmware updates that may be used with the printing devices 110 of the network system 100.

As a stand-alone program, the diagnostic tool of the present invention may reside in a memory of the network administrator computer system 160, or be operated from a storage media accessible to the network administrator computer system 160. For instance, the diagnostic tool may be stored on a hard disk drive of the network administrator computer system 160 and accessed as needed during execution of the diagnostic tool. Once accessed, the diagnostic tool may be used to monitor the firmware versions operating on the various network devices of the network system 100.

One feature of the diagnostic tool of this embodiment is the ability to detect and monitor the various devices using firmware and operating with the network system 100. Any device operating firmware may be detected and monitored by the diagnostic tool. Alternatively, a network administrator, or other user, may add a network device to a list of devices monitored by the diagnostic tool. For example, if a new printing device 110 is added to network system 100 while the diagnostic tool is executing on the network administrator computer system 160, the diagnostic tool may automatically detect the addition of the new printing device 110 and add the printing device 110 to a list of printing devices 110 that are monitored by the diagnostic tool. Alternatively, the network administrator may inform the diagnostic tool of the new printing device by selecting an executable for the addition of a printing device to a list of printing devices 110 being monitored by the diagnostic tool. A list of the printing devices 110 monitored by the diagnostic tool may be stored in a memory or on a storage device accessible to the diagnostic tool.

Once a printing device 110, or other network device, has been added to a list of monitored devices, the diagnostic tool may monitor the firmware of the device. Monitoring the firmware of a particular device may consist of determining the version of the firmware operating on the device and determining if any updated versions of the particular firmware exist that may be used to update the device firmware.

The diagnostic tool may be used to surf the Internet 900 to determine whether or not updated versions of firmware are available for the various devices being monitored by the diagnostic tool. If an updated version of firmware is available, the diagnostic tool may automatically download the updated firmware from a remote computer 190 to a storage location on the network system 100. Once downloaded, the updated firmware may be downloaded or written to the programmable ROM of the network devices.

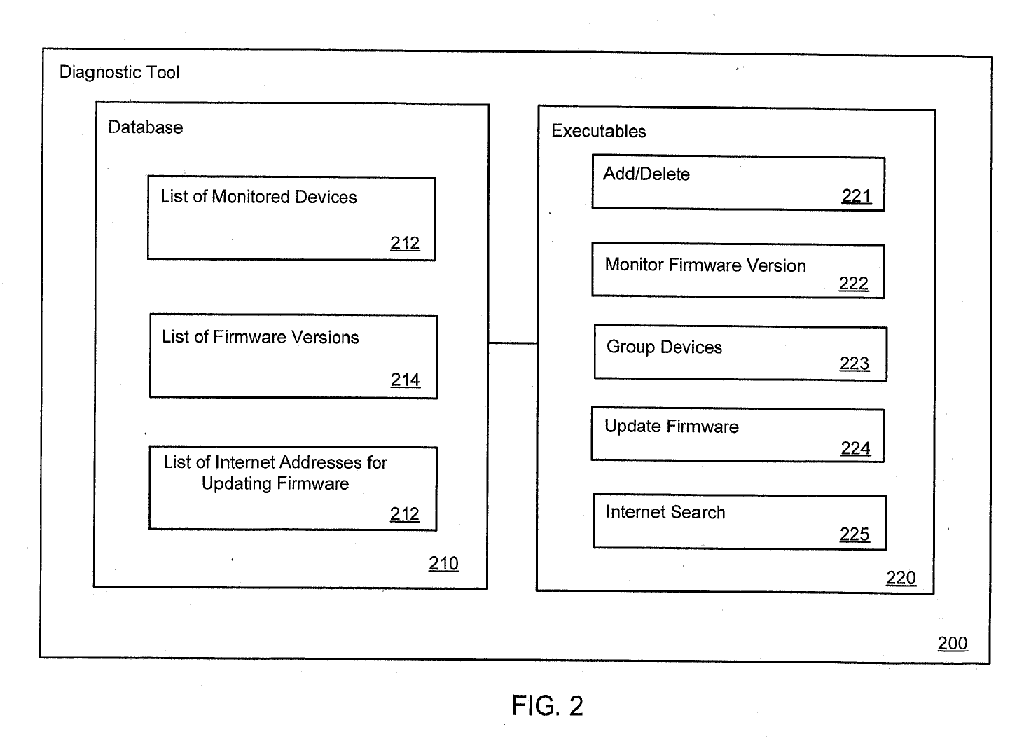

Representative executables and data that may be carried out or used with the various embodiments of the present invention are further illustrated in the block diagram of FIG. 2 as components of a diagnostic tool 200 program. The diagnostic tool 200 may include one or more databases 210 for storing information about the devices attached to a network system 100. The diagnostic tool 200 may also include a set of executables for carrying out the various functions associated with the various embodiments of the present invention.

The databases 210 accessible to and created by the diagnostic tool 200 may include a database 212 for storing a list of monitored devices. Each network device associated with the network computer system that utilizes firmware may be included in database 212. A second database 214 may store a list of the various firmware versions associated with the network devices listed in database 212. In other words, the current firmware version operating on the monitored devices of database 212 are stored in the second database 214. Optionally, database 212 and second database 214 may be combined into a single database.

A third database 216 may store a list of Internet addresses associated with a particular device for retrieving updated versions of firmware. The diagnostic tool 200 may use the Internet addresses stored in the third database 216 to obtain updated versions of firmware. The third database 216 may also be combined with database 212, second database 214, or both databases in a single database.

The executables 220 associated with the diagnostic tool 200 carry the various functions and procedures associated with the present invention. An add/delete executable 221 may be employed to add or delete a network device to a database 212 storing the list of devices for monitoring. When a new device is added to a network system 100, a network administrator may execute the add/delete executable 221 of the diagnostic tool 200 for adding the device to a list of devices that need to be monitored. The add/delete executable 221 may add the device name to the database 212 as well as record the firmware version in the second database 214 and record any embedded Internet addresses for updating the firmware in the third database 216. Internet addresses for firmware updates may be embedded in a device memory or functionality and may be obtained using PML, Perl or Parsed Markup Language. Once added, a device may be monitored and controlled by the diagnostic tool 200.

An executable for monitoring firmware versions 222 may also be invoked by a user or carried out automatically by the diagnostic tool 200. The executable for monitoring firmware versions 222 may query the network devices of the network system 100 on a periodic basis to ascertain the version of the firmware being operated on those devices. When monitoring the firmware versions, the diagnostic tool 200 may compare the current version of the firmware to the most recent version of available firmware. If the current version of firmware is outdated, the diagnostic tool 200 may prompt the network administrator with a notification of the updated firmware availability, or the firmware may be automatically updated.

In those instances where the firmware of a device may be updated, the diagnostic tool 200 may automatically execute the update firmware executable 224. Alternatively, a network administrator or other user may execute the update firmware executable 224. Upon execution, the update firmware executable 224 may retrieve the most recent version of firmware from a remote location via an Internet connection or from a storage device or memory associated with the network system 100. Once retrieved, the updated firmware may be installed on a selected network device by the diagnostic tool 200.

The diagnostic tool 200 may also provide an executable for grouping devices to allow for simultaneous firmware updates for multiple devices or simultaneous monitoring of certain groups of network devices. The group devices executable 223 allows a user or network administrator to choose and group various network devices that are monitored by the diagnostic tool 200. Usually, the devices that may be grouped are selected from the list of monitored devices from database 212. Devices may be grouped according to different variables, such as functionality, size, performance, output, or other variable that may be monitored by the diagnostic tool 200 or a network management program 162.

An Internet search executable 225 for searching the Internet 900 for firmware updates may also be configured with the diagnostic tool 200. The Internet search executable 225 may be manually executed by a user or configured by a user or network administrator to execute automatically on a set time schedule. Once executed, the Internet search executable 225 retrieves the list of Internet addresses for updating firmware from the third database 216 and begins to check the retrieved addresses for updated firmware versions. The existing version of firmware hosted by a particular web site may be compared to the list of firmware versions stored in the second database 214. If a more recent, or updated, firmware version is found, the Internet search executable 225 may download the updated firmware and save it to a storage device associated with the network system 100. The downloaded firmware may then be automatically installed on an associated network device or stored until the update firmware executable 224 is executed.

Using the diagnostic tool 200, a network administrator may maintain updated firmware and software versions across an entire network system 100. The process may also be automated, freeing up the valuable time of the network administrator to perform other necessary tasks. In addition, the diagnostic tool 200 allows a network administrator to group devices so that different versions of firmware may be operated on different groups of devices across a network system 100. For instance, it may be desirable to maintain an older firmware version on one or two printing devices in the network system 100 to avoid configuration errors with other devices. Using the diagnostic tool 200 of the present invention, a network administrator could group all but the two printing devices for a firmware upgrade. Thus, the two printing devices not in the group would not be updated.

In another embodiment of the present invention, the diagnostic tool for monitoring and updating firmware on network devices associated with a network system 100 may be incorporated with a network management program 162. Typically, network management programs 162 monitor the various devices of a network system 100 for different actions, occurrences, or errors. The incorporation of the diagnostic tool of the present invention with a network management program 162 allows the network management program 162 to also monitor and update the firmware associated with the network devices of the network system 100. Heretofore, network management programs were not configured to monitor and update the firmware of network devices.

For example, the diagnostic tool of the present invention may be incorporated with the Web JetAdmin network management program 162 distributed by Hewlett-Packard®. In addition to performing the functions associated with monitoring the status of printing devices in the network system 100, the integration of the diagnostic tool would provide the Web JetAdmin program the capability for monitoring and updating the firmware of the printing devices associated with the network system 100. A network administrator could use the combination of the Web JetAdmin program and the diagnostic tool of the present invention to more thoroughly control and manage the printing devices, or other devices, connected to network system 100. In addition, the diagnostic tool may provide Web JetAdmin the ability to surf the Internet 900 to locate remote computers 190 hosting firmware updates that could be automatically downloaded. The ability of the diagnostic tool to allow the automation of firmware updating may ultimately save a network administrator time and provide a more efficient process for updating firmware across enterprise or network systems 100.

In another embodiment of the present invention, the diagnostic tool may be configured to monitor and manage programs installed in a memory of a network device, such as a flash memory. For instance, embedded web servers, such as Hewlett-Packard's® ChaiVM, may be monitored and the version of the software determined. Using the diagnostic tool 200, updated versions of software or patches may be found and downloaded from a remote location via the Internet. The software may then be updated. Other programs stored in flash memory or duel inline memory modules (DIMM) that may also be monitored include Digital Sender software and Mopier Firmware, also by Hewlett-Packard®.

Although the examples and descriptions herein include descriptions of Hewlett-Packard® devices and programs, it is understood that the diagnostic tool of the present invention, and the various described embodiments thereof, may be used to configure any device having firmware stored in a memory. In addition, firmware from any remote computer may be available over the Internet and downloadable by the present invention.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method for monitoring firmware on a network device, comprising:
communicating with at least one network device utilizing firmware;
determining a version of firmware utilized by said network device from said communication; and
recording the version of firmware utilized by said network device and a device name for said network device.

2. The method of claim 1, further comprising:
determining if said version of firmware is the most recent version of firmware available for said network device.

3. The method of claim 2, wherein said determining if said version of firmware is the most recent version of firmware available for said network device, comprises:
communicating with a computer remote from the network device to determine the latest version of firmware available for a particular network device; and
comparing said latest version of firmware to said recorded version of firmware utilized by said network device.

4. The method of claim 3, further comprising:
obtaining an Internet address associated with firmware updates from said network device; and
communicating with said remote computer at said Internet address.

5. The method of claim 4, wherein said obtaining an Internet address associated with firmware updates form said network device comprises obtaining said Internet address from Perl Markup Language variables garnered from said network device.

6. The method of claim 3, further comprising automatically updating said version of firmware on said network device if said latest version of firmware is newer than said version of firmware utilized by said network device.

7. The method of claim 3, further comprising notifying a network administrator of said latest version of firmware if said latest version of firmware is newer than said version of firmware utilized by said network device.

8. A method for maintaining firmware updates on a device, comprising:
determining at least one device for monitoring;
determining a version of firmware operating on said at least one device;
comparing said version of firmware operating on said at least one device with a recent version of firmware; and
updating said version of firmware operating on said at least one device if said version of firmware operating on said at least one device is outdated.

9. The method of claim 8, wherein said determining at least one device for monitoring comprises retrieving a list of devices for monitoring from a storage location selected from the group consisting of a memory and a storage device.

10. The method of claim 8, wherein said determining at least one device for monitoring comprises querying a network communication link for determining any devices connected to said network communication link.

11. The method of claim 8, wherein said determining a version of firmware operating on said at least one device comprises retrieving a firmware version number from said device.

12. The method of claim 8, wherein said comparing said version of firmware operating on said at least one device with a recent version of firmware comprises:
determining a most recent firmware version for said firmware operating on said at least one device; and
comparing said determined version of firmware operating on said at least one device with said determined most recent firmware version.

13. The method of claim 12, wherein said determining a most recent firmware version for said firmware operating on said at least one device comprises:
retrieving an Internet address from said at least one device; and
using said diagnostic tool to query information at said Internet address for retrieving said
most recent firmware version for said firmware operating on said at least one device.

14. The method of claim 8, wherein said updating said version of firmware operating on said at least one device if said version of firmware operating on said at least one device is outdated comprises:
retrieving an Internet address from said at least one device;
downloading said most recent firmware version from said Internet address; and
installing said most recent firmware version on said at least one device.

15. The method of claim 8, wherein said updating said version of firmware operating on said at least one device if said version of firmware operating on said at least one device is outdated comprises updating each of said at least one devices operating said outdated firmware.

16. A system for monitoring firmware on network devices, comprising:
a network computer system;
at least one network administrator computer in communication with said network computer system;
at least one network device having firmware in communication with said network system, said network device utilizing firmware; and
a firmware monitoring program accessible to said at least one network administrator computer.

17. The system of claim 16, wherein said firmware monitoring program comprises:
an executable for obtaining a firmware version designation from said at least one network device for said firmware operating on said at least one network device;
an executable for searching the Internet for firmware updates; and
an executable for updating firmware on said at least one network device.

18. A computer program for monitoring firmware on a network device, comprising:
programming for communicating with a network device utilizing firmware;
programming for determining a version of firmware used by said network device;
programming for recording an identifier for said network device and said version of firmware determined by said computer program.

19. The computer program of claim 18, further comprising programming to determine if said version of firmware used by said network device is the most recent version of firmware available for said network device.

20. The computer program of claim 18, wherein said programming for determining a
version of firmware used by said network device, comprises:
programming for querying a firmware version from firmware operating on said network device;
programming for querying a database to compare said firmware version operating on said network device to a latest version of firmware available for said device ;and
programming for notifying a user of a more recent firmware version.
